(19) United States
(12) Patent Application Publication
(10) Pub. No.: US 2026/0027459 A1
(43) Pub. Date: Jan. 29, 2026

(54) APPLICATION METHOD AND APPARATUS

(71) Applicant: Sony Interactive Entertainment Inc., Tokyo (JP)

(72) Inventors: Paul Terence Mulligan, Sheffield (GB); Andrew William Walker, London (GB); Jessica Rose Grant, Hertfordshire (GB); Mohammad Mansoor Nusrat, London (GB); Anthony Graziano, London (GB); Owen Bruce Keys, London (GB); Geoffrey Maxwell Everitt, Surrey (GB); Ashley Morton-Bye, Oxfordshire (GB)

(21) Appl. No.: 19/281,496

(22) Filed: Jul. 25, 2025

(30) Foreign Application Priority Data
Jul. 26, 2024 (GB) 2410964.7

(51) Int. Cl. A63F 13/49

(52) U.S. Cl. CPC A63F 13/49

(57) ABSTRACT

A method of accessing the state of a currently operating application comprises a second application accessing and saving copies of plural memory values relating to the state of the currently operating application as an anchor memory value set, the second application accessing and saving copies of changes to said memory values as a delta memory value set, more often than saving an anchor memory value set, and forming a snapshot of the currently operating application at a selected moment by combining a preceding anchor memory value set and subsequent delta memory value sets up to said selected moment.

### BACKGROUND OF THE INVENTION

### Field of the Invention

The present invention relates to an application method and apparatus.

### Description of the Prior Art

Conventional applications, and in particular video games, can create a save-file that provides a means for that application to start, or re-start at a particular point the game, or more generally a particular state of the application. This can be very useful for games that are intended to be completed over multiple play sessions.

Typically, these save files are intended to be used only by the person who caused the save file to be made. In part this is because if such a save file is used by someone else, then that becomes their current game state and future game saves will be from that basis; this can negate their own in-game progress until that point, unless they know how to access earlier game saves of their own (which in turn will negate any progress made using the new game file). Furthermore, such save files are often hard to distribute because they are intentionally hard to access in order to avoid inadvertent damage by a user, and even if such a file is received from a friend, it may not be clear where it should be saved in order to work as desired.

Accordingly, embodiments of the present description seek to address or mitigate these problems.

### SUMMARY OF THE INVENTION

Various aspects and features of the present invention are defined in the appended claims and within the text of the accompanying description.

In a first aspect, a method of accessing the state of a currently operating application is provided in accordance with claim 1.

In another aspect, an entertainment device configured to access the state of a currently operating application is provided in accordance with claim 15.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an entertainment device in accordance with embodiments of the present description.

FIG. 2 is a schematic diagram of functional components of an entertainment device in accordance with embodiments of the present description.

FIG. 3 is a schematic diagram of image frames and data snapshots in accordance with embodiments of the present description.

FIG. 4 is a schematic diagram of snapshots in a branching timeline in accordance with embodiments of the present description.

FIG. 5 is a flow diagram of a method of accessing the state of a currently operating application in accordance with embodiments of the present description.

### DESCRIPTION OF THE EMBODIMENTS

An application method and apparatus are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

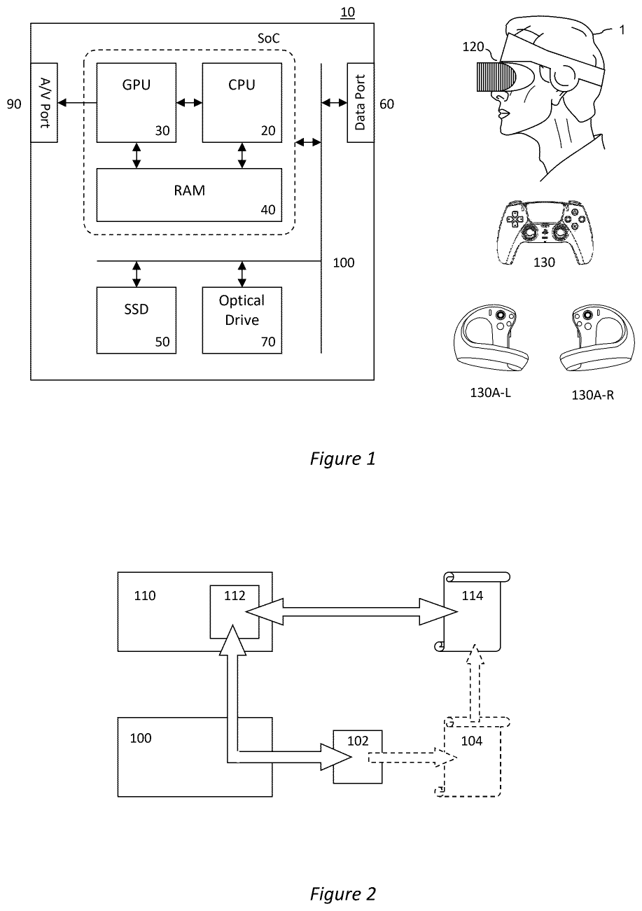

Referring now to the drawings, wherein like reference numerals designate identical or corresponding parts throughout the several views, FIG. 1 shows an example of an entertainment system 10, such as a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50. Where components are not integrated, they may be connected as appropriate either by a dedicated data link or via a bus 100.

The entertainment device may transmit or receive data via one or more data ports 60. It may also optionally receive data via an optical drive 70. Audio/visual outputs from the entertainment device are typically provided through one or more A/V ports 90 or one or more of the data ports 60. An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

### Snapshots

Referring now also to FIG. 2, embodiments of the present description may be used with applications (hereafter ‘games’, but potentially encompassing other application types where progress can be saved); these applications may be adapted to better facilitate the techniques herein, or in some embodiments may be so-called ‘legacy’ games that are not adapted to the techniques herein, and operate transparently and substantially in ignorance of these techniques.

In embodiments of the present description, the entertainment device's operating system, or equivalently a helper app (e.g. in so-called ‘middleware’) hereafter collectively referred to as the OS 100, compiles data relating to the state of the game 110 while it is being played.

In particular it compiles data 102 representing changes in memory 112 that affect the gameplay logic.

Typically these memory locations correspond to variables identifying things such as player health, player location, player role and equipment, and optionally non-player character data, typically for non-player characters (‘NPCs’) within interaction range or whose own data has been observed to change. Other data relevant to game play, such as environmental elements (e.g. whether a door is flagged as locked or open) may similarly be saved.

More generally, the gameplay logic maintains a model of the game state so that it can determine e.g. one or more of player and non-player/object statistics and statuses, item collection, collision detection, the meeting of quest goals, and the like. In other words, it manages the progress/evolution of the game state according to the game's rules/logic and the user(s)′ actions. The gameplay logic may thus be thought of as the game engine (not to be confused with the game's graphics engine).

Notably, any non-gameplay-logic related elements of the game, such as a full or partial rendering pipeline, audio outputs, user camera movements, Ul rendering etc., are typically not part of the game play logic and changes in memory due to the operation of these functions do not affect gameplay logic but are generally implementing the consequences/output of that logic for the user.

Memory locations relating to gameplay logic can be tracked using pointer chains from a static part of memory which then reliably indicates the same in-memory state feature (e.g. player health, score, position, etc). Games typically have predefined memory structures and so these locations can be derived for a game title, either by human inspection or through automated testing. For example, such automated testing can be used to determine correlations between actions/outcomes in-game and value changes within the variables used by the game logic in a methodical manner, so as to identify the purpose of these variables (as represented by memory values).

Such inspection or testing may be of the game 110 itself and/or of a game save file 114; in particular, identifying what values in the game save file are written to what locations in the game logic memory when the file is loaded, or vice-versa when a game is saved, can usefully identify relevant memory locations to monitor, and also a mechanism to compare different game states if this is done, for example, remotely or subsequently.

In any event, using such techniques, data equivalent to at least some of the data created by a game save can be created by the entertainment device without active participation by the game during game play. Typically the data created by a game save that relates to the game save's formatting and to invariant data do not need to be extracted and saved.

Typically the entertainment device will extract and save/record data in two forms:
1. So-called anchor data, representing the full state of the gameplay logic. Optionally the anchor data may comprise just those parts of the data that, combined with defaults (e.g. invariant or assumed state data), provide the full state—for example at the start of a particular game level, it could just be the player's score and current number of lives, if all else starts in a default setting. Meanwhile for a different game it could require more details about the state of the user, but not of NPC characters that have default initial conditions. In other cases, some NPCs may have different states as well depending on the game progress to date. The anchor data can be saved in response to one or more of a user input, an elapsed period (e.g. every few minutes), and/or in response to in-game events detectable by the entertainment device OS or helper app (e.g. intercepting an automatic or manual game save by the game and duplicating relevant data to generate or help generate the anchor data, or when the game logs that a trophy has been obtained/updated, or when a cut-scene is accessed or terminates, or when a threshold amount of new environmental data is accessed, indicating that a new part of the game is about to be presented).
2. So called delta data, which is sent either any time there is a change in memory 112 that affects the gameplay logic, or when a threshold number of changes have occurred, and/or periodically (e.g. every few seconds, or every second, or every N(=2,3,4,5, etc.) or every other frame, or with every frame). Typically each delta data item or data set will be assigned an index number, and the index number and new data are saved together.

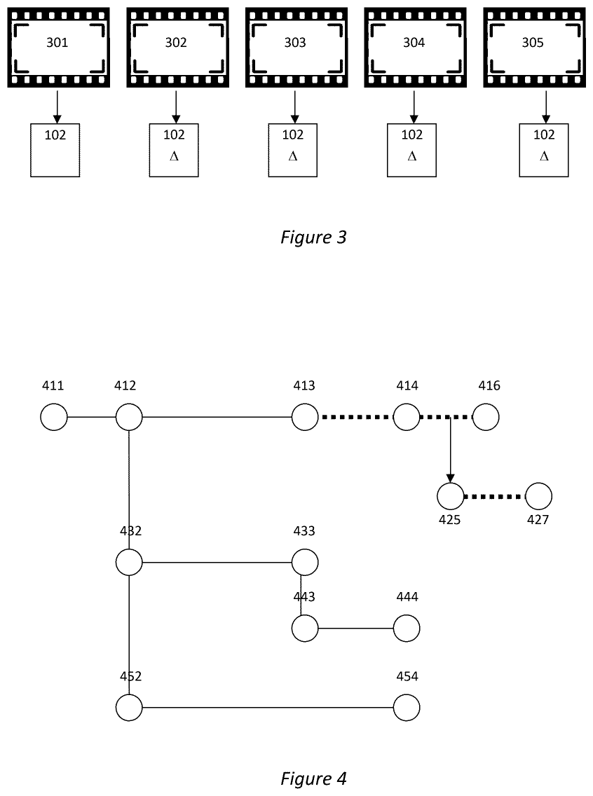

Hence referring to FIG. 3, for example, anchor data 102 may recorded for a first frame 301 of a game in response to one of the criteria described elsewhere herein, and delta data 1024 may then be recorded respectively for subsequent frames 302-305, or equivalently for first and subsequent periods or criteria where these periods are not related to frame rate. Each set of data is associated with metadata that allows it to be identified within the data sequence and optionally with time stamps, frame numbers, a preceding anchor data set, and/or other data items, as described later herein. To distinguish anchor data and delta data from conventional game saves, they are referred hereafter collectively as ‘snapshots’.

In this way snapshots for the state of the game at any given moment can be recorded to a sufficient degree that, optionally in conjunction with default state data (e.g. game state data that is necessary but has not changed in the game/current session/level, and so does not need to be saved in the snapshot), it can be used to reconstruct the game state at that given moment.

Optionally the reconstructed data could be (also) formatted as a save game 104, so that it can be accessed and loaded within the game like any other. This can be used to create save games at positions other than predefined save points, thereby creating the option of manual game saves for a player of a legacy game that only has fixed save points.

It will be appreciated that such a scheme could similarly be used to create automatic saves for any game, and this functionality could be used in addition to or instead of automatic saves by a game developer.

Alternatively or in addition, the reconstructed data could be copied directly into the relevant memory locations 112 within the game, to make the game jump to that state. In this case optionally the game may be made to pause, to assume it has just loaded a save game, to restart, or to use an existing feature like a help menu (for example based on changing values in an API or other predetermined memory element) so that the game would automatically load graphical and other game assets when resuming with the replaced memory values. If the game is interrupted in this manner, optionally an OS overlay user interface can be provided to browse snapshots as described later herein.

### Timelines

Notably, the snapshots can be recorded as a time-series database, so that a user can select a given moment in time, and the game state can be synthesised from the preceding anchor data and cumulative delta data thereafter, before being output as a game save or as a direct modification to the game's current state data in memory. In the former case, the game may be prompted to use the newly created save game in a normal fashion. In the latter case, this can enable a user to summon a user interface of the entertainment device (e.g. of the OS/helper app) and access a time slider Ul or similar to move back and forwards in time and see the game state change in real time based on the recorded data (e.g. by reference to associated screen shots).

As noted above, the OS is in effect creating save data periodically and potentially at every frame of game play. Optionally this may be done within a circular buffer, for example for the last 15 minutes, or between conventional game saves; the buffer period may be determined by storage availability.

Meanwhile optionally anchor data may be saved more permanently, but optionally again on an interim scheme such as on a last-in, last-out basis with a maximum number of available slots to limit storage use.

In this way, periodic or event-driven snapshots may be created that are persistent between (potentially multiple) game sessions, and moment-by moment save data is created within a current session, optionally in a buffer for a preceding N minutes.

A user may then elect to permanently save a particular anchor data set as a snapshot outside of any interim scheme, or similarly permanently save a snapshot from anchor data and available delta data for a specific moment. As a result, at least for the period for which delta data is currently available, the user can define a precise save game point. Meanwhile notable moments within the game may also be saved as anchor points and reviewed by the user for more permanent access. Such permanent snapshots can optionally be deleted by the user or by another save game scheme in a similar manner to other game saves.

The recorded data can be stored locally, or in an upload to a server in association with a user account, or similarly to a cloud streaming environment. The upload may comprise the time-series database if the user still wants to explore their game history, or those snapshots specifically saved or identified by the user, or just the most recent cumulative data (or a game save or snapshot thereof) if the user just wants to have a ‘continue from last state’ save function available (e.g. if this is not normally available in a legacy game).

These snapshots typically complement the conventional save games created by the game itself, and these can optionally also be included within a timeline of available snapshots based on when they were created.

### Snapshot Management

Having the ability to revisit earlier game states, and then play the game from those game states, can require management of the resulting snapshots for the user, as they will create branching versions of their game play as a result.

Referring to FIG. 4, in an example-only scenario a user starts a game and anchor data is saved as a snapshot 411. Later during play, there is a key choice to be made, and anchor data is saved as a snapshot 412.

The user continues with their first choice and encounters a boss they feel they cannot tackle; anchor data is saved as a snapshot 413.

The user then tries a different earlier choice, by going back to snapshot 412 and making a new choice as snapshot 432. However, this leads again to the boss, now as snapshot 433.

The user finally tries a third choice from snapshot 412, leading to snapshot 452. This bypasses the boss, leading to a game state 454.

However the user feels like they are missing out of the boss fight (and possibly rewards from it) and so revisits snapshot 433, and switches from using a crossbow to using a gun; anchor data is saved as a snapshot 443. Using the gun, the user beats the boss and anchor data is saved as a snapshot 444.

The user has now experienced how to beat the boss, and so decides to try beating them using their preferred build of character, and so returns to snapshot 413, and proceeds to beat the boss with a sword; anchor data is saved as a snapshot 414.

The player then proceeds to get a particularly lucky reward from the boss for using a sword, which they want to keep, but then accidentally dies at point 416.

Rather than go back to snapshot 414 and risk not getting the lucky reward a second time, the user chooses to access the deltas for the recent period of play (denoted by the dotted line in FIG. 4), and branch off just before the accident occurred, to create new snapshot 425. This time, the user avoids the accident and reaches their goal, and anchor data is saved as a snapshot 427.

In the above example, deltas are only available for the current session (or last N minutes thereof), but optionally could be available for more of the branching game set; for example a server could maintain anchors and deltas for all the user's game play, for example as part of a premium subscription service.

Optionally, in the above snapshot management example, each snapshot may get a screenshot or short video capture of the game at that time associated with it, to provide the user with additional context/recall of the game as defined by that snapshot.

The above management is in effect of one or more in-game timelines as defined by play based on respective snapshots. However the same snapshots may alternatively or in addition be managed according to other criteria, based on analysis of the values in a snapshot, or their difference with respect to preceding or following snapshots, or with respect to analysis of a wider corpora of snapshots, as described elsewhere herein. Instead of a time line view, snapshots could be organised by gameplay style (e.g. heavy action, high speed, distance covered, health status, loot collected, etc), or relative rarity or uniqueness of situation compared to a wider corpus of snapshots, or relative ease or difficulty compared to a wider corpus of snapshots.

### Image Tagging

Whilst it is noted above that a snapshot may get an associated screenshot or video for management of a user's own progress, conversely a screenshot or video may be provided with at least a first associated snapshot, e.g. for the purposes of being shared. In this case, when the screenshot or video is subsequently viewed (e.g. either by the original user or by anyone with access, for example where the screenshot or video is shared online), if this is viewed using a device operable to implement the techniques herein, then the user could ‘jump in’ to the game at the point shown in the screenshot or video by virtue of using the associated snapshot in the manner described elsewhere herein.

Typically the snapshot would not be part of the screenshot file, and similarly for a video the snapshot (or series of snapshots, depending on the periodicity of snapshot creation) would not be part of the video file—although in both cases this is clearly an option. Rather, to keep file sizes close to normal, the screenshot file may comprise a URL or similar resource locator (for example as part of image metadata) that the entertainment device can use to request the snapshot from a server, where it is stored for this purpose. Similarly a video file may have a URL or similar resource locator (for example as part of video metadata) to a single snapshot, or may have multiple such locators corresponding to different frames in the video where multiple snapshots are associated with respective moments in the game depicted in the video.

When viewing a screenshot or a video on a device implementing the techniques herein, the user can provide an input indicating a wish to jump into the game at the illustrated moment.

The OS of the device may then identify the snapshot from the metadata, or identify the snapshot most closely preceding the timing of the user input, in the case of multiple snapshots in a video, and request that snapshot from the server.

In the case that the user already has the game installed on their device, the server may then return the snapshot to the OS of the device. The OS may then start the game (or modify it as described elsewhere herein, if already running) with the data from the snapshot, so that the game state is as depicted in screenshot or video.

Optionally, the game may be started, or set, to operate in a limited mode when using a snapshot not created by the current user, for example one or more of:
not saving any new snapshots (so that the game play, which may be arbitrarily related to the user's own game play, does not get incorporated into their own game management);
only playing for a limited period of time (for example for a default or specified maximum period such as 15 minutes) or until a specific goal is achieved. This approach may make use of existing activity card systems on the device to set up the restrictions;
Not logging any trophies awarded during game play, as these in effect do not wholly originate with the current user; and
Not awarding any form of in-game (or real) currency that persists beyond play of the present snapshot.

Hence more generally, snapshots not created by the current user can be used in a sandbox mode, to a greater or lesser extent. The OS can define settings within the game (and/or within the OS itself) to suppress snapshots and/or trophies, define gameplay termination criteria, and manage currency values held in game memory or wallets.

Hence in summary, users can distribute enhanced images and videos that allow other users to jump into the game at that point, optionally in a manner that does not affect their own separate game progress.

In the case that a user does not already have the game installed on their device when they provide an input indicating a wish to jump into the game at the illustrated moment, then optionally the game can be offered to them according to whatever conditions apply to normal access to that game.

Further optionally the game can be offered in a locked-down ‘demo’ mode, that only plays the shared snapshot for a limited period of time or until a specific goal is achieved. Similarly such a locked down game may be able to play one or more snapshots in this manner until a total time period has been used (for example an hour or more), so that the user can have several experiences but cannot use a series of shared snapshots to effectively access all the game without restriction.

In the above instance, the game can be offered either for download to the user's own device, or optionally offered via a game streaming service. The latter is more secure for distribution purposes, and also allows for play on devices that could view an image or video but may not be capable of playing the associated game.

### Game Data Analysis-Single Game Instance

Having access to the key variables defining gameplay within a snapshot can allow for the creating of challenges between players.

For example two snapshots may be used as follows: a first snapshot from a first player is used to define the initial game state for a challenge (for example specifying the type of car and race track for a race). A second snapshot is recorded at the end of the race, which captures the first player's performance.

A second player can then play the game using the first snapshot, and when they finish the race themselves, their performance can be compared with that of the first player based on the data in the second snapshot.

Where a second snapshot is used, potentially any number of relevant variables may be compared between the players to provide a detailed comparison.

Alternatively, a specific challenge snapshot could be provided where one or more variables are selected by the first player (or a developer) as the basis for comparison. In this case optionally the first snapshot can be augmented with outcomes for these variables (e.g. ‘challenge variables’ or ‘challenge memory values’) at the end of the challenge. In this way, only one snapshot is required to define a challenge. Optionally, such a snapshot may comprise deltas for the selected challenge variables over the course of the challenge, to provide a live, moment-by-moment comparison between the first player and the subsequent second player accessing the challenge. The comparison may be provided for example by an overlay generated by the OS.

The first user could define the start of the challenge (thereby triggering the creation of the first snapshot), and select the relevant challenge criteria either at the start or optionally at the end (e.g. so they can assess their performance and choose the most challenging metric)—when the user indicates that the challenge is over, the deltas for the relevant variable(s) can be added to the first snapshot.

Optionally, the first user may not need to explicitly define the start and end of the challenge; for example a challenge could be associated with an activity card or other fixed section of a game,

In any event, in this way users can post challenges by circulating screenshots or videos with associated links to challenge mode snapshots, indeed simply circulate the snapshots with appropriate descriptions.

### Game Data Analysis-Game Corpus

Whilst the above analysis relates to a single performance, there is also scope to analyse snapshots from a corpus of multiple users.

These users may be conventional users of the game, but alternatively or in addition may be quality assurance testers, early access players, or automated play-through systems. These early users of the game can advantageously provide snapshot data that can be analysed to provide useful material at or near the official launch of the game, whereas data from conventional users necessarily can only be gathered after launch.

In particular, a corpus of snapshots from different players enables the gathering of information on one or more of the following:
the range of values for each of the variables within the game
the distribution of values for each of the variables within the game
correlations (positive and/or negative) between values for each of the variables within the game
the relationship between any of the above and in-game progress/time/location (typically also in-game variables).

Hence more generally, the cumulative data from multiple snapshots of a corpus of users allows analysis of the possible state space of the game, in terms of its extent, common/uncommon states, and constraints both positive and negative on the form of the state space.

Hence for example it would be possible to determine correlations between maximum health levels and skill levels or character classes, the distribution of health losses incurred when encountering a particular boss enemy, and whether it is seemingly impossible to beat that boss when equipped with a certain weapon.

Accordingly, based on this information, a challenge snapshot could be synthesised that set the challenge of beating the boss with a health loss achieved only by 10% of players, and equipping the user with a weapon known to be able to beat the boss with because of a positive correlation.

More generally, challenges can be created by identifying game states that positively correlate with a particular outcome achieved by N % of users, where N % is a relatively small percentage that may be determined for example by the level of challenge (e.g. easy=25%, moderate=10%, and hard=5%).

In addition to synthesising challenge snapshots based on the corpus of data as described above, the technique can similarly be used to provide bespoke challenges for a given user; based on a user's own recent snapshot, their current game state can be determined. A subset of similar game states can then be derived from the corpus to identify subsequent outcomes achieved by N % of users.

Hence more generally synthesised challenges can start from any initial game state, based upon characterisation of the state space, or may start from a game state corresponding to that of an individual user, based upon characterisation of the state space for that circumstance.

The snapshot may be synthesised using variable values corresponding to the desired initial point in game state space, optionally in conjunction with default state data, and the challenge may be added in the form of target value(s) for the relevant variable(s) based on the point in game state space achieved by the N % of players, in a similar manner to that described previously for challenge snapshots. Again deltas for a representative one of those N % of players, or deltas based on an average of some or all of those N % players, could be included to provide a moment-by-moment live comparison.

Hence returning to the example of a driving game, analysis of the state space may indicate that only 5% of people win a particular race when driving a particular underpowered car, and so this can be synthesised as a general ‘hard’ challenge snapshot. Alternatively, if a user currently has a more powerful car in the game, analysis of the state space may indicate that only 5% of people win the race in that car in under 4 minutes, and so this can be a ‘hard’ challenge, tailored to the user's current game state. A user may be offered either type of challenge, optionally with the one based on their own game state persisting within their game progress, whilst the other type is sandboxed as an isolated experience.

The game state analysis may also be used to validate snapshots or challenges synthesised ‘manually’ by players or developers; for example, optionally a user (player or developer) may be allowed to directly select variable values to set up a particular game state that they don't have access to. Hence rather than create a challenge of beating their own race time, a user could create a challenge to do that in a different car, or to beat it by 10 seconds, or the like. The game state analysis could then check the corpus to see if that outcome appeared to be possible-if the result appeared to be outside the game state space, the user could either be told not to proceed, or the resulting challenge could be labelled as (likely) impossible.

As well as challenges, more cooperative uses of snapshot synthesis may be considered. For example a first and second player may be friends, and the first friend wants to share their game experience with the second friend. The second friend could take the snapshot and experience the game exactly as their friend played it. Alternatively, they could opt to keep their game character (e.g. health character class, inventory and the like) while jumping into their friend's snapshot, by the OS either replacing character related values in their copy of the snapshot, or masking character related values when applying the snapshot. In this way a synthesis of the first friend's game, and the second friends avatar, could be created.

Like the challenges described previously, optionally the resulting game state may be checked (e.g. by a server) to see if it was within the game state space; for example it may be that the first player was exploring underwater, and needed an aqualung item (e.g. indicated by a 100% correlation between the relevant game variables within the corpus) that the second player character does not have. In this case, apparently required character traits such as this could then be added to from the snapshot make the synthesised game state work as a playable experience.

It will be appreciated that the above may apply to modifying any aspect of the game state during cooperative synthesis, and such synthesis may not be limited to combining game situations and player avatars.

Hence more generally two game states can be combined in any suitable fashion, and the result can be validated against the game state space obtained from analysis of the corpus, and be modified if necessary to reside within it.

Finally, users may be allowed to modify game values the change one or more aspects of the game state space itself, for example applying a global health limit, or changing gravity values, or making setting the number of non-player enemies to zero to create a ‘zen’ version of the game that can be explored in a peaceful manner. Such changes may break game logic and result in states where progress is not possible (for example, if a non-player enemy held a key needed to progress further, but no longer appears), even result in a game crash. Hence again if a snapshot is synthesised that falls outside the empirically determined game state space, this can trigger a warning, and also can enforce playing of the game from the snapshot in a sandboxed mode that will not affect more conventional game progress.

As noted above, positive and negative correlations between variables may be determined and used to limit or modify synthesised snapshots so that they work in a manner intended by the game developer. Some correlations may be 100% positive or negative, indicating a necessary condition of the game, and these can be detected in a straightforward manner. Indeed, any degree of correlation can be determined using known techniques.

Optionally, correlations between at least some snapshot variables may be detected using machine learning. This may be of use when the correlations are complex or conditional (for example correlations between two variables changing based on a relationship between one of those variables and a third variable). Hence for fuzzy, conditional, or multidimensional correlations, a machine learning system such as a neural network may be appropriate. A neural network, for example, may elegantly handle a fuzzy condition such as whether a particular weapon is preferred based on both location (e.g. a particular region or terrain type in-game), character, and probability of an enemy spawning.

### SUMMARY

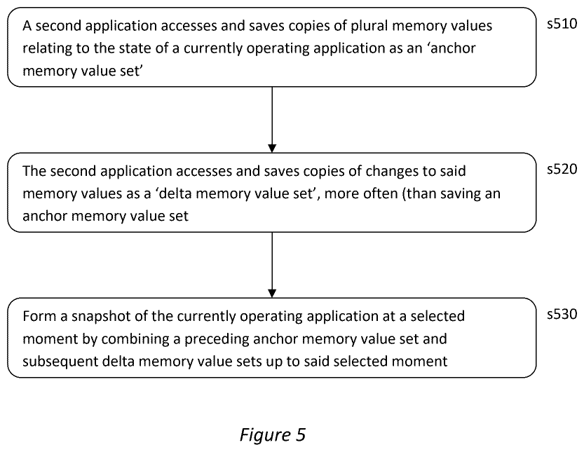

Referring now to FIG. 5, in a summary embodiment of the present description, a method of accessing the state of a currently operating application comprises the following steps.

In a first step s510, a second application (e.g. the OS or a helper app thereof) accessing and saving copies of plural memory values relating to the state of the currently operating application (e.g. a game) as an ‘anchor memory value set’, as described elsewhere herein.

In a second step s520, the second application accessing and saving copies of changes to said memory values as a ‘delta memory value set’, more often (e.g. with higher frequency) than saving an anchor memory value set, as described elsewhere herein.

In a third step s530, forming a ‘snapshot’ of the currently operating application at a selected moment by combining a preceding anchor memory value set and subsequent delta memory value sets up to said selected moment, as described elsewhere herein.

It will be appreciated that the snapshot may be formed when saving the data in response to selecting a moment, or may be formed then or later as an interim step in creating either a save game or in redefining/overwriting the state of another or later instance of the operating application.

It will be apparent to a person skilled in the art that variations in the above method corresponding to operation of the various embodiments of the apparatus as described and claimed herein are considered within the scope of the present invention, including but not limited to that:
the state of the currently operating application comprising the values used by a logic of the currently operating application to control the evolution of progress of the operation of the currently operating application, as described elsewhere herein;
the memory values saved comprise values used by the logic of the currently operating application that differ from default or initial values, and the step of (immediately or subsequently) forming a snapshot further comprises combining saved memory value sets with unchanged default or initial values, as described elsewhere herein;
anchor memory value sets are saved in response to one or more event or timing criteria, and delta memory value sets are saved when one or more selected from the list consisting of there is any change in one of the plural memory values, a threshold number of changes within the plural memory values have occurred, and every or every N^{th} frame of output by the currently operating application, as described elsewhere herein;
the method comprises the step of associating a snapshot with at least a first image frame output by the currently operating application at the selected moment (e.g. as a snapshot or as part of a video clip), as described elsewhere herein, and optionally the association may be used to provide the frame output as an aide memoire for the snapshot, or to provide access to an associated snapshot from the frame, as appropriate, as described elsewhere herein;
the method comprises the step of generating a save file compatible with the currently operating application using data from the snapshot, as described elsewhere herein;
the method comprises the step of the second application replacing memory values of the operating application with memory values from a snapshot previously taken of an instance of the operating application (whether the same instance or one on a different computer or user account), so that the operating application assumes an operating state defined by the snapshot, as described elsewhere herein;
if the operating application reverts to a state defined by data from a snapshot previously taken of an instance of the operating application (optionally only if that instance was one on a different computer or user account), the operating application operates in a so-called sandbox mode limiting permanent changes to data that can be made by the operating application, as described elsewhere herein;
   similarly, saving a snapshot for local subsequent use may result in the definition of branching timelines for parallel versions of game play progressed from these snapshots, as described elsewhere herein;
the method comprises the steps of receiving inputs from a user that define a challenge, the challenge being definable by changes to one or more memory values stored by a snapshot, the memory values being referred to (for convenience) as ‘challenge memory values’ and modifying the snapshot to include both the initial one or more challenge memory values and one or more changes to the one or more challenge memory values that occur when the user is completing the challenge, optionally defining just the endpoint criteria, or optionally defining a series of values to enable ongoing comparisons during the challenge, as described elsewhere herein;
the method comprises the steps of obtaining a plurality of snapshots from a corpus of users, and using the values within the plurality of snapshots, estimating one or more selected from the list consisting of the value ranges of some or all of the set of plural memory values, the value distribution of some or all of the set of plural memory values, correlations between different values of some or all of the set of plural memory values, and relationships between any of the preceding list items and progress within the operating application, to estimate a state space that the plurality of snapshots occupy, as described elsewhere herein;
   in this instance, optionally the method comprises the steps of synthesising a snapshot comprising a challenge, the challenge being definable by changes to one or more memory values stored by a snapshot, the memory values being referred to as challenge memory values; wherein the synthesised snapshot comprises a challenge corresponding to transitioning from a first application state to an application state that positively correlates with a particular outcome achieved by a predetermined proportion of users of the operating application, optionally based on variations of a current player's own game state, as described elsewhere herein;
   again in this instance, optionally the method comprises the steps of validating a combined snapshot formed by combining values from two separate snapshots against the estimated state space, and if the combined snapshot falls outside the estimated state space, performing one selected from the list consisting of modifying one or more values of the combined snapshot so that it falls within the estimated state space, and incorporating a warning that the combined snapshot may cause the operating application to perform incorrectly, as described elsewhere herein; and again in this instance, optionally the estimation of the state space that the plurality of snapshots occupy comprises detecting correlations between two or more of the plural memory values by machine learning, as described elsewhere herein.

It will be appreciated that the above methods may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, and referring now again to FIG. 1, in a summary embodiment of the present description an entertainment device is configured to access the state of a currently operating application, and comprises the following.

A processor (for example CPU 20) configured by a second application (e.g. the OS or a helper app other than the currently operating application) to access and save copies of plural memory values relating to the state of the currently operating application, as an anchor memory value set, as described elsewhere herein.

The processor also configured by the second application to access and save copies of changes to said memory values as a delta memory value set, more often than saving an anchor memory value set, as described elsewhere herein.

The entertainment device (typically the processor thereof) is configured (again by suitable software instruction, typically by the second application, and not by the currently operating application) to form a snapshot of the currently operating application at a selected moment by combining a preceding anchor memory value set and subsequent delta memory value sets up to said selected moment, as described elsewhere herein.

Instances of this summary embodiment implementing the methods and techniques described herein (for example by use of suitable software instruction) are envisaged within the scope of the application.

It will be appreciated that the apparatus and techniques herein advantageously provide the means for one or more selected from the list consisting of:
saving games at arbitrary points, when the game itself only support saving games at fixed points
selecting when to branch off from a current game timeline to explore alternative outcomes/content
creating user defined challenges for others to complete
creating challenges based on the aggregate state space of plural snapshots, either independent of a user's current game state, or responsive to that game state;
validating combined snapshots that allow users to share their experiences, or provide interactive help by letting users combine familiar aspects of their own game experience with the game state of the helper;
linking snapshots to image frames or videos so that viewers of those images or videos can jump into the action they depict, optionally even if they do not have the relevant game or hardware to natively play it on.

It will be appreciated that the above advantages are not reliant in any form on the schemes, rules, or methods of playing a particular game, and indeed apply to other non-game application types where there is cumulative progress inherent in their use.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of accessing the state of a currently operating application, comprising:
a second application accessing and saving copies of plural memory values relating to the state of the currently operating application as an anchor memory value set;
the second application accessing and saving copies of changes to said memory values as a delta memory value set, more often than saving an anchor memory value set; and
forming a snapshot of the currently operating application at a selected moment by combining a preceding anchor memory value set and subsequent delta memory value sets up to said selected moment.

2. The method of claim 1, wherein the state of the currently operating application comprises the values used by a logic of the currently operating application to control the evolution of progress of the operation of the currently operating application.

3. The method of claim 2, wherein:
the memory values saved comprise values used by the logic of the currently operating application that differ from default or initial values; and
the step of forming a snapshot further comprises combining saved memory value sets with unchanged default or initial values.

4. The method of claim 1, wherein:
anchor memory value sets are saved in response to one or more event or timing criteria; and
delta memory value sets are saved when one or more selected from the list consisting of:
i. there is any change in one of the plural memory values;
ii. a threshold number of changes within the plural memory values have occurred; and
iii. every or every N^{th} frame of output by the currently operating application.

5. The method of claim 1, further comprising:
associating a snapshot with at least a first image frame output by the currently operating application at the selected moment.

6. The method of claim 1, further comprising:
generating a save file compatible with the currently operating application using data from the snapshot.

7. The method of claim 1, further comprising:
the second application replacing memory values of the operating application with memory values from a snapshot previously taken of an instance of the operating application, so that the operating application assumes an operating state defined by the snapshot.

8. The method of claim 1, wherein:
if the operating application reverts to a state defined by data from a snapshot previously taken of an instance of the operating application, the operating application operates in a so-called sandbox mode limiting permanent changes to data that can be made by the operating application.

9. The method of claim 1, further comprising:
receiving inputs from a user that define a challenge, the challenge being definable by changes to one or more memory values stored by a snapshot, the memory values being referred to as challenge memory values; and
modifying the snapshot to include both the initial one or more challenge memory values and one or more changes to the one or more challenge memory values that occur when the user is completing the challenge.

10. The method of claim 1, further comprising:
obtaining a plurality of snapshots from a corpus of users, and using the values within the plurality of snapshots, estimating one or more selected from the list consisting of:
i. the value ranges of some or all of the set of plural memory values;
ii. the value distribution of some or all of the set of plural memory values;
iii. correlations between different values of some or all of the set of plural memory values; and
iv. relationships between any of items i.-iii. and progress within the operating application,
to estimate a state space that the plurality of snapshots occupy.

11. The method of claim 10, further comprising:
synthesising a snapshot comprising a challenge, the challenge being definable by changes to one or more memory values stored by a snapshot, the memory values being referred to as challenge memory values; wherein
the synthesised snapshot comprises a challenge corresponding to transitioning from a first application state to an application state that positively correlates with a particular outcome achieved by a predetermined proportion of users of the operating application.

12. The method of claim 10, further comprising:
validating a combined snapshot formed by combining values from two separate snapshots against the estimated state space; and
if the combined snapshot falls outside the estimated state space, performing one selected from the list consisting of:
i. modifying one or more values of the combined snapshot so that it falls within the estimated state space; and
ii. incorporating a warning that the combined snapshot may cause the operating application to perform incorrectly.

13. The method of claim 10, wherein:
estimation of the state space that the plurality of snapshots occupy comprises detecting correlations between two or more of the plural memory values by machine learning.

14. A system comprising:
one or more computers; and
one or more storage devices storing instructions that, when executed by the one or more computers, cause the one or more computers to perform operations comprising:
accessing and saving, by a second application, copies of plural memory values relating to the state of the currently operating application as an anchor memory value set
accessing and saving, by the second application, copies of changes to said memory values as a delta memory value set, more often than saving an anchor memory value set; and
forming a snapshot of the currently operating application at a selected moment by combining a preceding anchor memory value set and subsequent delta memory value sets up to said selected moment.

15. The system of claim 14, wherein the state of the currently operating application comprises the values used by a logic of the currently operating application to control the evolution of progress of the operation of the currently operating application.

16. The system of claim 15, wherein:
the memory values saved comprise values used by the logic of the currently operating application that differ from default or initial values; and
the step of forming a snapshot further comprises combining saved memory value sets with unchanged default or initial values.

17. The system of claim 14, wherein:
anchor memory value sets are saved in response to one or more event or timing criteria; and
delta memory value sets are saved when one or more selected from the list consisting of:
i. there is any change in one of the plural memory values;
ii. a threshold number of changes within the plural memory values have occurred; and
iii. every or every N^{th} frame of output by the currently operating application.

18. One or more computer-readable storage media storing instructions that when executed by
one or more computers cause the one or more computers to perform operations comprising:
accessing and saving, by a second application, copies of plural memory values relating to the state of the currently operating application as an anchor memory value set
accessing and saving, by the second application, copies of changes to said memory values as a delta memory value set, more often than saving an anchor memory value set; and
forming a snapshot of the currently operating application at a selected moment by combining a preceding anchor memory value set and subsequent delta memory value sets up to said selected moment.

19. The computer-readable storage media of claim 18, wherein the state of the currently operating application comprises the values used by a logic of the currently operating application to control the evolution of progress of the operation of the currently operating application.

20. The computer-readable storage media of claim 19, wherein:
the memory values saved comprise values used by the logic of the currently operating application that differ from default or initial values; and
the step of forming a snapshot further comprises combining saved memory value sets with unchanged default or initial values.
